(19) United States
(12) Patent Application Publication
(10) Pub. No.: US 2015/0363791 A1
(43) Pub. Date: Dec. 17, 2015

(54) BUSINESS ACTION BASED FRAUD DETECTION SYSTEM AND METHOD

(71) Applicant: Hybrid Application Security Ltd., Sde-Boker (IL)

(72) Inventors: Raviv RAZ, Tel-Aviv (IL); Avraham AMINOV, Bnei-Braq (IL)

(21) Appl. No.: 14/596,461

(22) Filed: Jan. 14, 2015

Related U.S. Application Data
(60) Provisional application No. 61/925,739, filed on Jan. 10, 2014.

(51) Int. Cl. G06Q 30/00; G06N 99/00

(52) U.S. Cl. CPC G06Q 30/0185; G06N 99/005

(57) ABSTRACT

A business action fraud detection system for a website includes a business action classifier to classify a series of operations from a single web session as a business action. The system also includes a fraud detection processor to determine a score for each operation from the statistical comparison of the data of each request forming part of the operation against statistical models generated from data received in a training phase and the score combining probabilities that the transmission and navigation activity of a session are those expected of a normal user.

### CROSS REFERENCE TO RELATED APPLICATIONS

This application claims priority from U.S. provisional patent application 61/925,739, filed Jan. 10, 2014, all of which are incorporated herein by reference.

### FIELD OF THE INVENTION

The present invention relates to network security systems generally and to real-time fraud detection in particular.

### BACKGROUND OF THE INVENTION

Tracking fraud in the online environment is a hard problem to solve. Fraudster tactics rapidly evolve, and today's sophisticated criminal methods mean online account fraud often doesn't look like fraud at all. In fact, fraudsters can look and behave exactly like a customer might be expected to look and behave. Accurate detection is made even more difficult because today's fraudsters use multi-channel fraud methods that combine both online and offline steps, any one of which looks perfectly acceptable but when taken in combination amount to a fraudulent attack. Identifying truly suspicious events that deserve action by limited fraud resources is like finding a needle in a haystack.

Consequently, customer financial and information assets remain at risk, and the integrity of online channels is at risk. Companies simply do not have the resources to anticipate and respond to every possible online fraud threat. Today's attacks expose the inadequacies of yesterday's online fraud prevention technologies, which cannot keep up with organized fraudster networks and their alarming pace of innovation.

Reactive strategies are no longer effective against fraudsters. Too often, financial institutions learn about fraud when customers complain about losses. It is no longer realistic to attempt to stop fraudsters by defining new detection rules after the fact, as one can never anticipate and respond to every new fraud pattern. Staying in reactive mode makes tracking the performance of online risk countermeasures over time more difficult. Adequate monitoring of trends, policy controls, and compliance requirements continues to elude many institutions.

The conventional technologies that hope to solve the online fraud problem, while often a useful and even necessary security layer, fail to solve the problem at its core. These solutions often borrow technology from other market domains (e.g. credit card fraud, web analytics), then attempt to extend functionality for online fraud detection with mixed results. Often they negatively impact the online user experience.

### SUMMARY OF THE PRESENT INVENTION

There is provided, in accordance with a preferred embodiment of the present invention, a business action fraud detection system for a website. The system includes a business action classifier classifying a series of operations from a single web session as a business action; and a fraud detection processor determining a score for each operation from the statistical comparison of the data of each request forming part of the operation against statistical models generated from data received in a training phase and the score combining probabilities that the transmission and navigation activity of a session are those expected of a normal user.

Moreover, in accordance with a preferred embodiment of the present invention, where the processor includes a query analyzer which analyzing at least one of: textual, numerical, enumeration and URL parameters in an incoming website request.

Further, in accordance with a preferred embodiment of the present invention, where the processor includes analyzers which analyzing at least one of: geo-location of an HTTP session, trajectory to a webpage of an HTTP session and landing speed parameters to the web page of an HTTP session.

Still further, in accordance with a preferred embodiment of the present invention, where the processor includes an operation classifier which determining which operation was requested in an HTTP request.

Additionally, in accordance with a preferred embodiment of the present invention, the fraud detection system also includes at least one statistical model storing the statistics of operation determined during a training phase of the system.

Moreover, in accordance with a preferred embodiment of the present invention, where the at least one statistical model is at least one statistical model per the population of users and at least one statistical model per user.

Further, in accordance with a preferred embodiment of the present invention, Where the statistical models include at least an operations model, a trajectory model, a geolocation model, a query model per operation and a business action model.

Still further, in accordance with a preferred embodiment of the present invention, the fraud detection also includes a rule editor to enable an administrator to define at least one rule that combines both statistical and deterministic criteria in order to trigger an alert in the system.

Additionally, in accordance with a preferred embodiment of the present invention, where each rule is at least one of the following types of rules: behavioral rule, geographic rule, pattern rule, parameter rule and cloud intelligence rule.

There is also provided, in accordance with a preferred embodiment of the present invention, a method for detecting business action fraud on a website. The method includes classifying a series of operations from a single web session as a business action; and determining a score for each operation from a statistical comparison of the data of each request forming part of the operation against statistical models generated from data received in a training phase. The score combining probabilities that the transmission and navigation activity of a session are those expected of a normal user.

Moreover, in accordance with a preferred embodiment of the present invention, where the determining includes analyzing at least one of: textual, numerical, enumeration and URL parameters in an incoming website request.

Further, in accordance with a preferred embodiment of the present invention, where the determining includes analyzing at least one of: geo-location of an HTTP session, trajectory to a webpage of an HTTP session and landing speed parameters to the web page of an HTTP session.

Still further, in accordance with a preferred embodiment of the present invention, the determining includes classifying which operation was requested in an HTTP request.

Additionally, in accordance with a preferred embodiment of the present invention, where the at least one statistical model is at least one statistical model per the population of users and at least one statistical model per user.

Moreover, in accordance with a preferred embodiment of the present invention, where the at least one statistical model is at least one statistical model per the population of users and at least one statistical model per user.

Further, in accordance with a preferred embodiment of the present invention, where the statistical models include at least an operations model, a trajectory model, a geolocation model, a query model per operation and a business action model.

Still further, in accordance with a preferred embodiment of the present invention, the method also includes a rule editor enabling an administrator to define at least one rule that combines both statistical and deterministic criteria in order to trigger an alert in the system.

Additionally, in accordance with a preferred embodiment of the present invention, where each rule is at least one of the following types of rules: behavioral rule, geographic rule, pattern rule, parameter rule and cloud intelligence rule.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of steps forming part of a business action of adding a new blog post;

FIG. 2 is schematic illustration of a business action based fraud detection system, constructed and operative in accordance with a preferred embodiment of the present invention;

FIG. 3 is a schematic illustration of elements needed for training the system of FIG. 2;

FIG. 4 is a schematic illustration of elements needed for operation of the system of FIG. 2;

FIG. 5 is a schematic illustration of elements of a query analyzer forming part of the system of FIG. 2; and

FIG. 6 is a schematic illustration of a hybrid statistical and deterministic fraud detection system using the system of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that prior art fraud detection systems utilize pattern matching systems with regular expressions to match previously defined signatures. Any event which doesn't match the signature is considered fraudulent. Some detection systems, such as web application firewalls, look at each request individually and thus, do not get a sense of how a legitimate user may operate over time as opposed to how a fraudster may operate.

These prior art systems are not sufficiently strong against current fraudsters. The present invention, on the other hand, may provide a statistical approach to detect fraud, looking at how a general population may utilize a website and at how a particular user may utilize the website. The present invention may provide a hybrid approach, using statistical models both for an entire population and for particular users. The present invention may have a training period, to build the statistical models which may remain static during “production”, once the training is finished. Alternatively, some of the statistical models may remain static during production while others may continue to be updated, even during production.

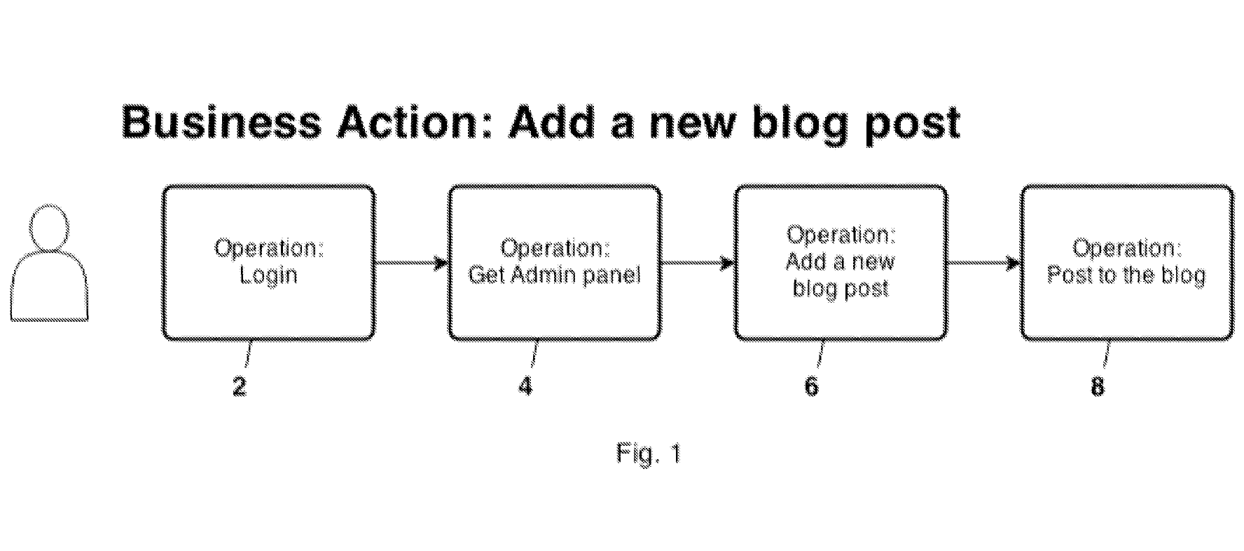

Applicants have also realized that a business defines fraud by looking at fraudulent “business actions” and not by detecting specific website or HTTP requests. For example, as shown in FIG. 1 to which reference is now made, one business action may be adding a new blog post, which may comprise four operations, login 2, “Get Admin panel” 4, “Add a new blog post” 6 and “Post to the blog” 8. Each of the operations may, in turn, be comprised of one or more HTTP requests. The present invention may handle such business action scenarios, as well as models of session intelligence (i.e. knowledge of how a user and/or the non-fraudulent population may operate during a session, such as a web session).

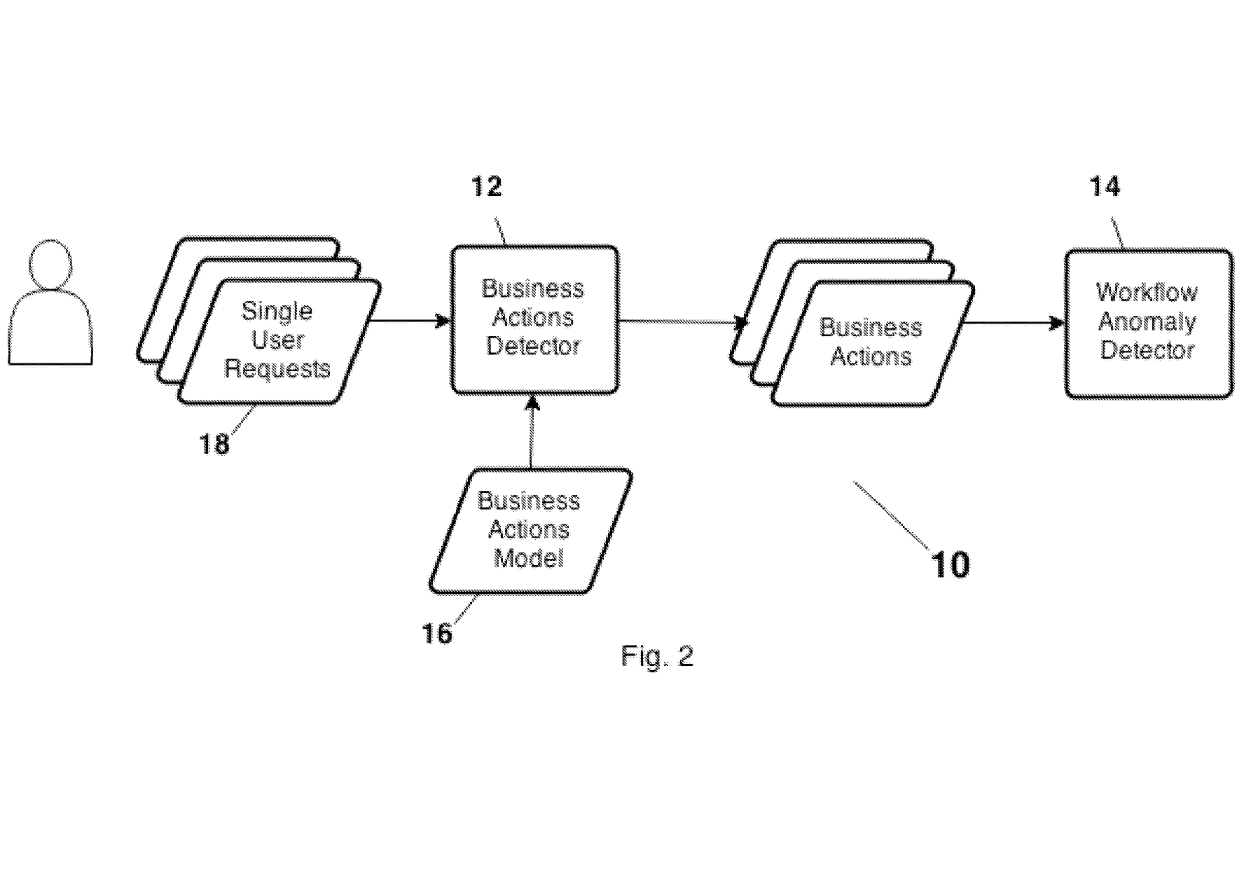

Reference is now made to FIG. 2, which illustrates a business action based fraud detection system 10, constructed and operative in accordance with a preferred embodiment of the present invention, to attempt to protect a website from fraudulent actions. System 10 may comprise a business action detector 12, a business action anomaly detector 14 and a business action model 16. Business action model 16 may store multiple types of business actions and business action detector 12 may compare multiple incoming single user requests 18 against the business actions stored in business action model 16. Thus, model 16 may store the money transfer action described in FIG. 1 and detector 12 may determine if a set of requests 18 may combine to be the money transfer action. If so, detector 12 may provide the detected set of actions to anomaly detector 14 to determine if the detected actions are consistent with the typical actions as defined in the training set.

Applicants have noticed that due to HTTP being a stateless protocol, web applications store the state of the system in the web application logic. As a result, the fraud detection mechanism (which is not an integral part of the web application), can only observe the possible output of the states, and not the states themselves. In order to have some estimation of the states in which the web application is in, business action model 16 may comprise a stochastic process model (such as a Hidden Markov Model or a Dirichlet Process) to infer the state transitions of the web application and their respective probabilities.

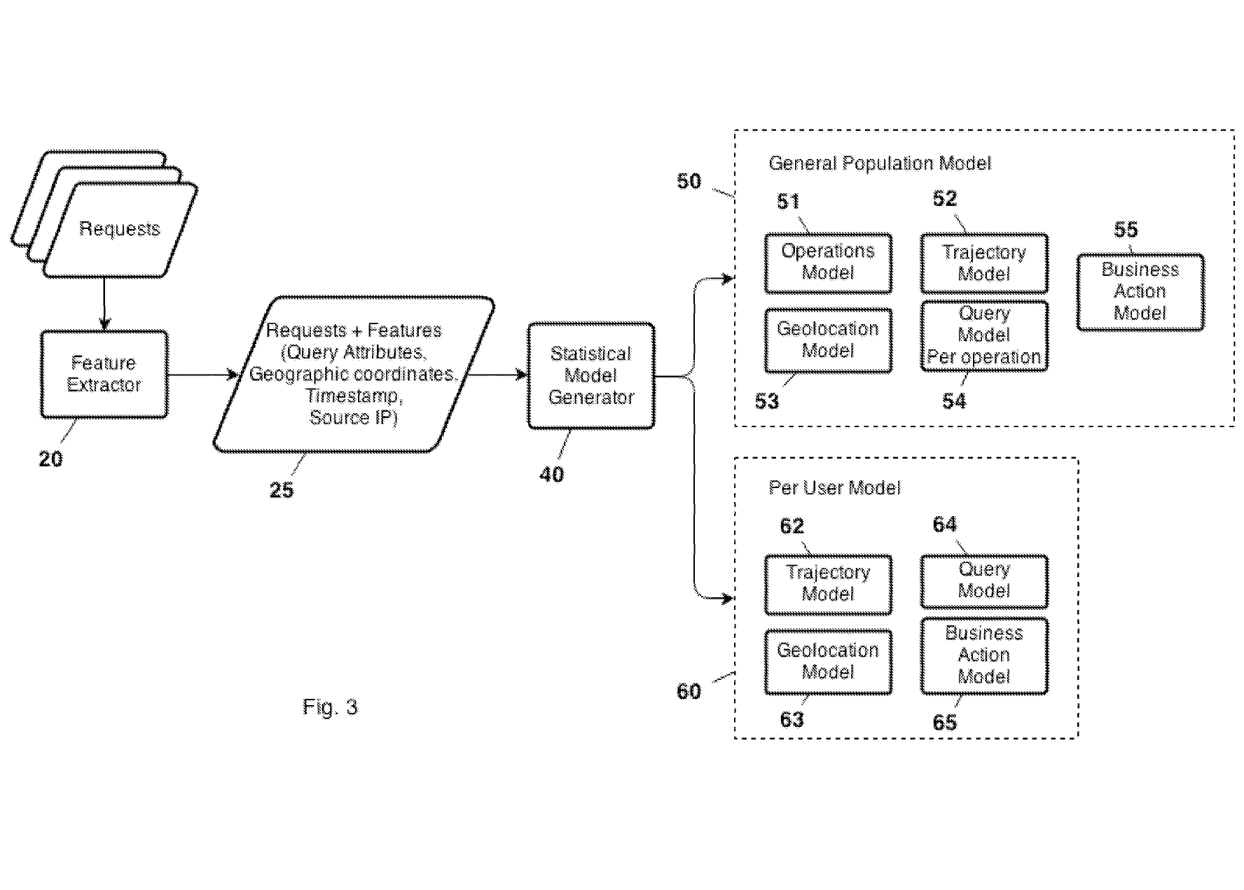

Reference is now made to FIG. 3, which illustrates the elements of system 10 utilized during the above mentioned training period, which may build the statistical models in accordance with an embodiment of the present invention. System 10 may comprise a feature extractor 20, a memory unit 25 and a statistical model generator 40 to generate both a population model 50 and a per user model 60. Feature extractor 20 may parse incoming HTTP requests and may classify the data therein into different data types. During the training phase, feature extractor 20 may operate on many thousands of requests and may store its output in memory 25. It will be appreciated that the data collected may be over a fixed time period depending on the traffic load of the requests into pertinent website.

Generally at the end of the training phase or at any desired point during the training, statistical model generator 40 may review the information in memory 25 and may determine the statistics of the different types of data stored therein, to build various statistical models to be stored in models 50 and 60 and to be used during the operation or production phase. Model 50 may store the statistical models for the entire population and each one of models 60 may store the statistical model for one user. It will also be appreciated that storing features in memory 25 may enable statistical model generator 40 to operate quickly, since reading a memory is faster than reading data from a disk or from a database.

It will be appreciated that models 50 and 60 do not store the data received during training; instead models 50 and 60 may store the statistics of the received data, stored in a manner, described in more detail herein below, to make it quick and easy for later analyzers to produce a score for newly received data.

Since, as is described in more detail herein below, system 10 may process different types of data using different types of statistical modeling, models 50 and 60 may comprise different sub-models. For example, population model 50 may comprise an operations model 51, a trajectory model 52, a geolocation model 53, a query model 54 and a business action model 55. Per user model 60 may comprise a trajectory model 62, a geolocation model 63, a query model 64 and a business action model 65, but storing the statistics of each user only. Business action models 55 and 65 together may form business action model 16 of FIG. 2.

As described in more detail herein below and as discussed in the article (“A multi-model approach to the detection of web-based attacks”, by C. Kruegel, et al., Computer Networks, Volume 48, Issue 5, 5 Aug. 2005, Pages 717-738), query model 54 may be based on the fact that when a legitimate user issues a request to the web server, there is a certain set of attributes that should appear in the request. Each such attribute has a certain type of values attached to it (numeric, enum/menu choice, URL or text). Query models 54 and 64 may store the statistics of these attributes such that, during production, system 10 may utilize query models 54 and 64 to assign an anomaly score for each request to a certain page/resource. For example, a request to a page called “login.asp” is very likely to be accompanied with the attributes “username” and “password”, which are both text fields that contain a certain set of characters. If the user requests the “login.asp” resource while supplying some extra attributes, this could be an attempt of misuse, and system 10, using query models 54 and 64, may produce a high anomaly score for such a request.

Trajectory models 52 and 62 may store the probability for a population of users or typical user to follow a certain path/trajectory/history of requests to pages. This is discussed in the article (“Defending On-Line Web Application Security with User-Behavior Surveillance”, by Y Cheng, et al., presented at the Third International Conference on Availability, Reliability and Security, 2008. ARES 08, March 2008). For example, statistically, most users log in to a website to view the content and post comments, and log out at the end of their visit and trajectory models 52 and 62 may model this typical use.

Recent years have witnessed the rise of very dynamic web applications (commonly referred to as Web 2.0) and also the rapid increase in use of mobile applications. These applications do most of their communication with the web server using a single resource called a web service. Each request to the server refers to the same web resource, but different sets of attributes and values determine a different operation to be performed by the server. Operations model 51 may model these types of requests, where an operation is defined by a URL (uniform resource locator) and a typical set of parameters and values that indicate that a service is being called to perform the operation. Referring to the example of FIG. 1, there may be 4 types of operations: login, view_post, comment and logout. They might be defined in the HTTP request as shown in the following table:

| # | URL | Query String |
|---|---|---|
| 1 | /blog.asp | ?action=login&username=demo1&password= |
| | | whatsmyname |
| 2A | /blog.asp | ?action=view_post&postID=11 |
| 2B | /blog.asp | ?action=view_post&postID=14 |
| 3 | /blog.asp | ?action=post_comment&postID=14&comment=thank+ |
| | | you+for +this+post |
| 4 | /blog.asp | ?action=logout |

As described in more detail herein below, operations model 51 may have a statistical model for each operation, which model stores the statistics of the typical set of attributes that are present whenever the particular operation is requested.

Geolocation models 53 and 63 may store the statistics of the geolocations of the users, typically based on their IP addresses.

It will be appreciated that an incoming HTTP request from a user may define what information a user may want to receive from the website protected by system 10 and may include the IP address of the requesting computer and/or its HTTP proxy, the requested document, the host where the document may be stored, the version of the browser being used, which page brought the user to the current page, the user's preferred language(s), a “cookie”, and any data used to fill in a form or menu choices. The operation being requested may also be described in the request attributes (i.e. i.e. HTTP headers, POST/GET parameters, XML/JSON data, etc.)

Feature extractor 20 may extract variables, or attributes, from the incoming HTTP requests. In addition, feature extractor 20 may extract information about transmission, such as IP address and/or timing information. Feature extractor 20 may extract the source and/or destination IP address information as well as timestamp information of when the request may have been created. Feature extractor 20 may also associate all of the data from a particular HTTP request with a session id and/or a user id.

Feature extractor 20 may store the variables and their values in memory unit 25 and statistical model generator 40 may periodically review the newly stored data to determine which type of data they represent, wherein the four types of query attribute data may be text, URL, number, or menu choice.

Moreover, since statistical model generator 40 may store the statistics of each variable, what type of statistics is stored is a function of the statistical model for each type of data. This will be described in more detail herein below. For previously seen variables, statistical model generator 40 may just add their values to the existing statistics for those variables.

However, for new variables, generator 40 may first typecast it (i.e. determine what type of data it represents), beginning with enumeration, since most web actions involve filing in forms of some kind. The order which generator 40 may follow may be enumeration, numeric, URL, text. Generator 40 may include a geolocation coordinate determiner (e.g. the MaxMind GeoIP database, described at http://www.maxmind.com/en/geolocation_landing) which may convert the source and/or destination IP addresses to geolocations and may generate statistics, as described herein below, on where the users are when they access the site being protected by system 10.

As mentioned hereinabove, during training, statistical model generator 40 may operate on whatever data has been received, continually updating the statistics, ideally until the statistics converge or stop changing significantly. Appendix A provides an Early Stopping algorithm for determining when to stop learning.

System 10 may also have a production mode, in which system 10 may score all new HTTP requests. However, in one embodiment, these new data are not added into the various models. In another embodiment, some adaptation may be allowed using these new data. The new training data may be periodically added to the statistical models used during production.

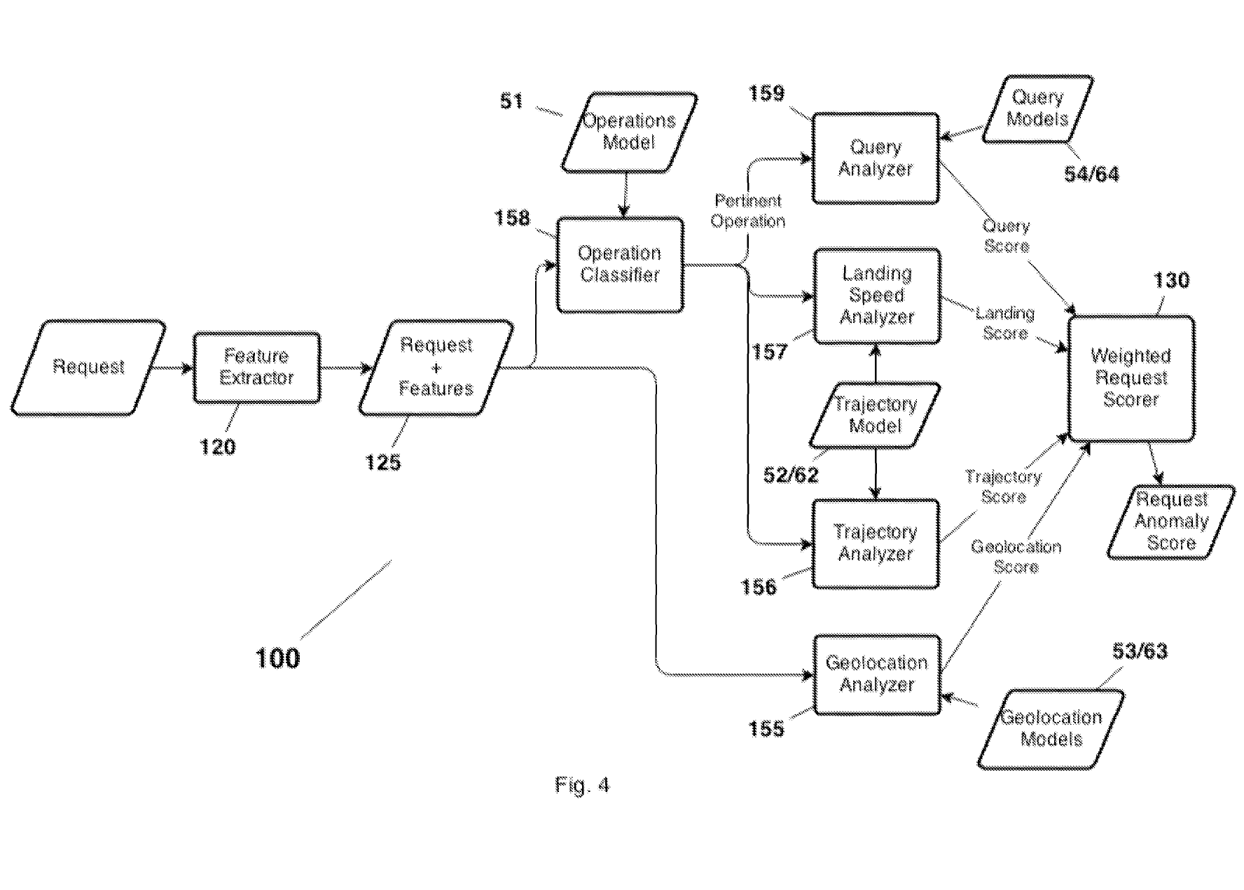

Reference is now made to FIG. 4 which illustrates a production unit 100 in accordance with an embodiment of the present invention. It will be appreciated that unit 100 may rely on statistical models 50 and 60 in order to determine any anomalies on an incoming internet request.

There may be multiple instances of unit 100 which may operate in parallel; for example, there may be 16 units 100 operating in parallel, which together may pull 16 objects from their relevant data cache at one time. It will be appreciated that, with parallel operation, system 10 may be able to process multiple HTTP requests in real-time.

Production unit 100 may comprise a production feature extractor 120, a production memory 125, multiple analyzers and a weighted request scorer 130. The multiple analyzers may include a geo-location analyzer 155, a trajectory analyzer 156, a landing speed analyzer 157, an operation classifier 158 and a query analyzer 159.

Production feature extractor 120 may operate similarly to feature extractor 20, extracting all relevant attributes and variables; however, since the variables were previously received and typecast by statistical model generator 40, production feature extractor 120 may directly provide each variable to its relevant analyzer 155-159.

Each analyzer may further utilize the relevant submodels of statistical models 50 and 60. Specifically, operations classifier 158 may operate with operations model 51, query analyzer 159 may operate with query models 54 and 64, trajectory analyzer 156 may operate with trajectory models 52 and 62 and geolocation analyzer 155 may operate with geolocation models 53 and 63. As described herein below, landing speed analyzer 157 may calculate landing speed, which does not require any model.

Using the URL, parameters and value that indicate an operation, operation classifier 158 may determine which operation is being performed, using operations model 51 in which each operation has its own statistical model which contains the typical set of attributes that are present whenever this operation is requested.

Operations model 51 may be generated as follows:

Operations Classification

The classification of requests to operations is based on a clustering technique. Operations classifier 158 may first translate the requests into numeric vectors in high dimensional real space, which is denote R̅. Let a request be a set of ordered pairs of attributes and their values:

R={(a₁, v₁ₐ,), (a₂, v_{2b}), . . . , (aₘ, vₘₖ)}, (1)

Where a₁, . . . , aₘ are all attributes that were classified at type enum (menu choices), that have a finite number of possible values. The different values vᵢⱼ represent the value of attribute aᵢ in that specific request, out of the possible values for aᵢ. Let Nᵢ be the total number of possible values for attribute aᵢ and Nₘₐₓ=max(Nᵢ). We now define a matrix R̅ ∈ [symbol] ₘ×Nₘₐₓ. The vector R̅ is defined as the fattened version of R̅. The matrix is defined as follows:

$${R}_{ij} = \{ \begin{matrix}\frac{{O}_{i}}{{N}_{i}} & if ( {a}_{i} , {v}_{ij} ) ∈ R \\ 0 & if ( {a}_{i} , {v}_{ij} ) ∉ R\end{matrix} , \qquad ( 2 )$$

where Oᵢ is the weight of the attribute base on its source (origin), and is given by

$${O}_{i} = \{ \begin{matrix}0.1 & if attribute is a header \\ 1 & \begin{matrix}if attribute is a GET attribute or a \\ urlencoded POST attribute\end{matrix} \\ 2 & if attribute is a JSON or XML attribute\end{matrix} \qquad ( 3 )$$

Note that if the attribute aᵢ does not appear in the request, the whole row i will be 0. This choice of representation ensures that operator selectors, which are almost always present, and have a small number choices, will be more dominant than regular menu choices, which don't always appear, and also may have a large number of possible values (for example: country selection upon registration). As mentioned earlier, the vector representation R̅ is obtained by simply concatenating the rows of R̅ into a one long row (i.e. flatten the matrix into an array). With the vector representations of the requests, operations classifier 158 may execute a clustering algorithm to find the possible clusters in the data. Each cluster produced by the clustering process is considered a single operation. To cluster without knowing the number of classes in advance, operations classifier 158 may use the DBSCAN algorithm, with the following exemplary parameters: [symbol] =0.3, MinPts=10. In addition, an amount of 5000 samples have proven to be more than enough to provide a reliable classification.

With the operation model 51 generated as described above, operation classifier 158 may utilize standard classification techniques to classify an incoming request or feature as a particular one of the operations stored in operation model 51. More specifically, operation classifier 158 may create a vector R from the page and attribute information of the incoming request and may calculate its mathematical distance from the centroid of each cluster stored in operation model 51. Operation classifier 158 may choose the closest cluster and may define it as the operation being requested.

Operation classifier 158 may provide the classified operation to query analyzer 159 which may select the statistics from its query models 54 and 64 for the classified operation.

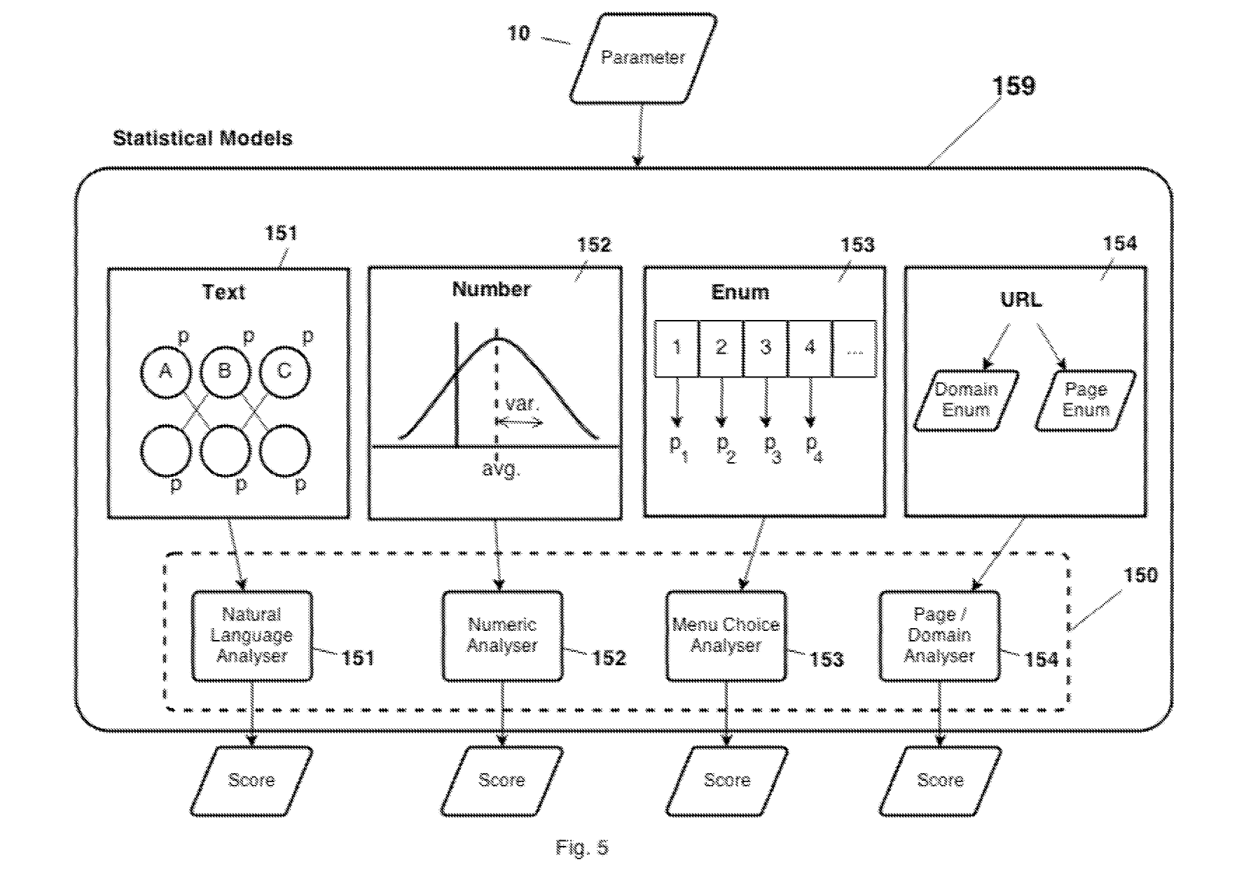

As shown in FIG. 5 to which reference is now made, query analyzer 159 may comprise a natural language processor 151 for analyzing text, a numerical analyzer 152 for analyzing numbers, an enumeration analyzer 15 for analyzing menu choices, and a URL analyzer 154 for analyzing pages and domains appearing inside query attributes.

Query analyzer 159 may send the pertinent parameter extracted by feature extractor 120 to the appropriate analyzer 151-154. For example, text may be sent to natural language processor 151 for analysis as described in more detail herein below. It will be appreciated that query analyzer 159 may handle text, numbers, menu selections and URLs.

It will be appreciated that natural language processor 151 may utilize a Markov graph tree, produced by statistical model generator 40 from the texts received from multiple users during the training phase and stored in query models 54 and 64. The graph tree may be utilized to determine if a newly received piece of text has been seen before (such as during the training phase).

Markov graph trees are discussed in (“Defending On-Line Web Application Security with User-Behavior Surveillance”) as is the process to produce them. Each node on the Markov graph tree gives a probability P(cᵢ) for the value it represents (such as an alphanumeric character) and each connection between nodes also has a probability P(c₁c₂) associated therewith, indicating the probability that the second character follows the first character.

During production, natural language processor 151 may take each piece of text in a given HTTP request and may move through each graph tree (in query models 54 and 64), scoring each letter in the piece of text by the probabilities given in each graph tree, according to Equation 4. The result may be a score for that piece of text in relation to query models 54 and 64.

$$P ( S ) = P ( {c}_{1} {c}_{2} … {c}_{k} ) = P ( {c}_{1} ) {\prod }_{i = 2}^{k} P ( {c}_{i} ) P T ( {c}_{i} ) \qquad Equation 4$$

where:

P(S)=probability of the string

P(c₁c₂)=probability of character c₂ following c₁ at the respective indices

PT(cᵢ)=Probability of transition cᵢ

Natural language processor 151 may handle individual words and groups of words. Each individual word may be processed as described hereinabove, resulting in a probability for each word. For each group of words, natural language processor 151 may determine a geometrical mean for the group of words.

Numerical analyzer 152 may utilize a numeric analysis algorithm which may, given a new number, determine how normal that new number is relative to the existing series of numbers in query models 54 and 64. Numerical analyzer 152 may then calculate a score according to how normal the new number is.

For numerical analyzer 152, normality may be measured by the distance of the new number x from a standard variance value of an existing series. To do this, numeric analyzer 152 may utilize the Chebyshev inequality to calculate an anomaly level ι for a new number x in a given series, where the given series is the data received during the training phase.

During the training phase, statistical model generator 40 may compute for each series the following: a mean value μ, a variance [symbol] ² and a standard deviation [symbol] . There may be one series per user and one series for the entire population. Statistical model generator 40 may store the mean value, variance and standard deviation for each series in the relevant ones of query models 54 and 64. When there are many training cycles, statistical model generator 40 may update the mean value, variance and standard deviation for each series as follows:

$${μ}_{NEW} = \frac{N {μ}_{OLD} + x}{N + 1} \\ {σ}_{NEW}^{2} = \frac{N {σ}_{OLD}^{2} + ( x - {μ}_{NEW} ) ( x - {μ}_{OLD} )}{N + 1} \qquad Equation 5$$

During the production phase, numerical analyzer 152 may utilize the following formula (Equation 6) for calculating the anomaly value ι, where p(X) may be the probability of X and (ι-μ) may be the distance of interest:

$$p ( \vert x - μ \vert > \vert l - μ \vert ) < p ( l ) = \frac{{σ}^{2}}{{( l - μ )}^{2}} \qquad Equation 6$$

Numerical analyzer 152 may determine distance (x-μ)² to generate p(ι). The output may be p(ι) except if the value of p(ι) is greater than 1, in which case, the output is 1. Otherwise, numerical analyzer 152 may provide the probability values p(ι) to query analyzer 159 as the relevant score.

Menu choice analyzer 153 may review menu choices, choices when filling in forms (e.g. cities, zip codes) or values generated automatically by scripts inside the page to indicate what operation is performed. It may use an algorithm which detects small lists of values and may increase performance by caching, in query models 54 and 64, the probabilities associated with the limited number of values chosen by users in the training phase.

Menu choice analyzer 153 may test to see whether a function representing a growing set of samples, comprised of the trained set and any new items added to it, and a function representing the appearance rate of different values in that set, have a negative or a positive correlation. If the correlation (i.e. normalized covariance) is negative, then the number of possible values is approaching a limit. If the correlation is positive, then the number of possible values continues to increase and we are not nearing a limit. Let the function representing the growth in samples be:

f(x)=x

And the function representing the appearance rate of detected values be:

$$\begin{matrix}ℊ ( x ) = \{ \begin{matrix}ℊ ( x - 1 ) + 1 , \\ if the {x}^{th} value for a is new \\ ℊ ( x - 1 ) - 1 , \\ if the {x}^{th} value was seen before \\ 0 , \\ if x = 0\end{matrix} & Equation 7 \\ Then \text{:} & \\ ρ = \frac{Covar ( f , ℊ )}{\sqrt{Var ( f ) * Var ( ℊ )}} & \end{matrix}$$

If ρ is less than 0, then f and g are negatively correlated and an enumeration is assumed. Else, if ρ is greater than 0, then the values of the parameter have shown enough variation to believe they are not drawn from a small, finite set of values.

For menu choice analyzer 153, statistical model generator 40 may determine the probability associated with each value received during the training phase, where the probability is an empirical probability function, meaning that the probability for each value is the occurrence number of that value in all the samples, divided by the total number of times the parameter appeared in all the samples, or:

P(value)=N(value)/N(parameter) Equation (8)

URL analyzer 154 may determine the Bayesian statistics of each page, each domain and the probability of each page given each domain. Thus, during the training phase, statistical model generator 40 may determine if an incoming attribute is of a URL type when it is a string which fits a URL format 95% of the times (excluding empty values). If that is the case, generator 40 may break the string into two parameters, Domain and Page, and may generate two probability functions:
a. P(domain)=#(appearances of domain)/#(appearances of parameter)
b. P(page|domain)=the conditional probability of observing the page, given the domain. This is an empirical distribution function

During the production phase, URL analyzer 154 may simply calculate P(page|domain)*P(domain) for the incoming URL.

Referring back to FIG. 4, query analyzer 159 may receive the probability output from natural language processor 151, numeric analyzer 152, menu choice analyzer 153, and URL analyzer 154 and may determine a Query Score as a weighted sum of the probabilities from each set of analyzers, per HTTP request, using Shannon's entropy of information, as follows:

$${w}_{i} = \frac{1}{1 + {S}_{i}} = \frac{1}{1 - {\sum }_{j} {p}_{j} log {p}_{j}} \qquad ( Equation 9 )$$

Where i is an index of a certain attribute, j is a certain value of the attribute, pⱼ is the probability of observing the value j and wᵢ is a weight for the ith attribute. The addition of 1 to the entropy in the denominator is to avoid division by zero for deterministic attributes (for which the calculated entropy would be zero).

Then, the total query score is calculated using a weighted sum over the attributes:

$$Query\_Score = \frac{{\sum }_{i} {w}_{i} ( 1 - {p}_{i , j} )}{{\sum }_{i} {w}_{i}} \qquad ( Equation 10 )$$

Where pᵢⱼ is the probability calculated by the statistical model generator 40 of observing the value j in attribute i using the appropriate model.

Referring back to FIG. 4, geo-location analyzer 155, trajectory analyzer 156 and landing speed analyzer 157 may operate on data of a session. For this, feature extractor 120 may determine a hash for each session ID such that each session may be uniquely identified and tied to multiple requests. Feature extractor 120 may provide the session ID to each analyzer 155, 156 and 157.

Trajectory analyzer 156 may determine the probability scores for users, pages and queries in the HTTP request, using a Markov analysis, similar to that of natural language analyzer 151. A userᵤₘ, as identified by a session cookie, or by a session identifier based on a unique browser fingerprint, may go to a page pₙ, as identified by the hostname+relative URL until a question mark, and may fill in query parameters Qₙ on that page. The query parameters Qₙ may be a tokenized list of (parameter, value) tuples, where each value is an attribute A_{k,n}.

The trajectory probability score may be determined according to equation 11, which is an iterative product of page transition probabilities, as follows:

P(pₙ|p1, p2, . . . , pₙ₋₁)=probability of visiting pₙ after visiting pages p1, p2, . . . , pₙ₋₁ in that order.

P(p₁|p₁₋₁)=probability of visiting page p₁ after visiting page p₁₋₁

$$P ( {p}_{n} \vert {p}_{1} , {p}_{2} , … , {p}_{n - 1} ) = P ( {p}_{1} ) {\prod }_{l = 2}^{n} P ( {p}_{l} \vert {p}_{l - 1} ) \qquad ( Equation 11 )$$

Note that the transition probabilities are originally determined after the training phase and are stored in each of trajectory models 52 and 62. Trajectory analyzer 156 may find each relevant probability and may determine P(pₙ|p1, p2, pₙ₋₁) according to Equation 11.

If desired, a system administrator may define legal and illegal trajectories through the pages of the website protected by unit 100. This may incorporate the business logic of the website.

Geo-location analyzer 155 may analyze the geographic locations of users. During the training phase, statistical model generator 40 may produce clusters containing the different coordinates for each user (stored in per user models 60) and/or over a population (stored in population model 50). During production, when a new geographic location relating to a new IP address for a particular user may be received, geo-location analyzer 155 may compute its normality by comparing it with the closest cluster radius and calculating an appropriate score.

During the training phase, statistical model generator 40 may utilize the DBSCAN algorithm to create initial clusters from the associated training data. Then it may recalculate the clusters every time a new coordinate appears for a particular user. In production mode, if the coordinate has other points around it in the cluster, geo-location analyzer 155 may measure its distance from the cluster center (centroid) and may compare it, using the numeric algorithm of Equation 6, against the rest of the Euclidean distances between the points in the cluster and its centroid. Like numerical analyzer 152, if the anomaly level ι is extremely anomalous, geo-location analyzer 155 may produce an immediate indication. The DBSCAN algorithm is provided in Appendix B herein below.

Landing speed analyzer 157 may first calculate a landing speed set as the series of all time offsets between one request and the next request, with respect to the page visitation order, within one session ID. Landing speed analyzer 157 may then perform a calculation, similar to that of numerical analyzer 152, to calculate the landing speed probability from one page to the next. Since landing speed for humans working from web applications may generally have a normal distribution nature, landing speed analyzer 157 may also determine whether the landing speed from one page to the next is common to a human and thus, may be able to determine when a non-human (e.g. an automated user) may be viewing pages of a website.

Weighted request scorer 130 may receive a query score from query analyzer 159, a landing score from landing speed analyzer 157, a trajectory score from trajectory analyzer 156 and a geolocation score from geolocation analyzer 155 and may generate a score per HTTP request using a weighted sum of these scores. Statistical model generator 40 may determine the weights during the training phase, based on the entropy of the scores. For this, generator 40 may treat the query score, landing speed score, and trajectory score as random variables and may calculate the entropy of each of them, Sₖ. The geolocation score acts as a flag:

$$Total\_Score = \{ \begin{matrix}\sqrt{{S}_{PF}} & if geolocation is anomalous \\ {S}_{PF} & if geolocation is normal\end{matrix} \qquad Equation 12$$

Where S_{PF} is the weighted sum of the query, landing speed, and trajectory score.

The rationale behind the score is that anomalous requests can originate both from normal locations and from anomalous locations. This is why there is an initial score (Spf) unrelated to the geo-location score. However, an anomaly score generated from an anomalous location should be amplified.

It will be appreciated that numerical analyzer 152, geolocation analyzer 155 and menu choice analyzer 153 may provide immediate alerts whenever their results are significantly anomalous.

In one embodiment, system 10 may classify new data as good or bad. In this embodiment, if the incoming HTTP request is classified as “good”, it will be assimilated into a good behavior model (per user and/or per population), and if it is classified as “bad”, it will be assimilated into the bad behavior model (also per user and/or per population). To eliminate false positive alerts, the system administrator may choose not to alert upon a newly-seen event. In this case, its appearance will be scored as 1/n where n is the number of samples relevant to this attribute, sampled during the training phase. This is called a “Laplace Correction”.

A request has to meet one of the following two conditions in order to be considered as a bad request: (1) The request triggered a rule (rules are described herein below) (2) The user marked an anomalous request as truly malicious.

Once a request is marked as bad, all of the parameter values in the request will be added to the “bad” class.

We then follow a classification mechanism similar to the one used for spam filtering based on a method initiated by Paul Graham and later developed further. The method is described by Gary Robinson in: http://www.linuxjournal.com/article/6467. We calculate the probability b(i,v) for an attribute i to have a value v in a bad request, and the probability g(i,v) for an attribute i to have a value v in a good request.

b(i,v)=(the number of bad requests containing i=v)/(total number of bad requests)

g(i,v)=(the number of good requests containing i=v)/(total number of good requests)

p(i,v)=b(i,v)/(b(i,v)+g(i,v)) is the probability that the request is “bad”.

In order to deal with rare values, a degree of belief is taken as the score:

$$f ( i , v ) = \frac{( s \cdot x ) + n \cdot p ( i , v )}{s + n} \qquad ( Equation 13 )$$

Where n is the number of times we observed the value, s is the strength of the background (i.e. the number of samples we would like to have before taking p(i,v) into account), and x is the assumed probability.

The combined probability of a request to be a bad request is:

$$H = {C}^{- 1} ( - 2 ln {\prod }_{i} f ( i , v ) , 2 n ) \qquad ( Equation 14 )$$

Where C⁻¹ is the inverse chi-square function (http://en.wikipedia.org/wiki.Chi-squared_distribution).

In particular, as described hereinabove, feature extractor 120 may determine a hash for each session ID. This hash may be added to each HTTP request that is stored in the bad database. If a new hash is matched to a “bad” one (i.e. one which is already in the bad database), all subsequent requests coming in from this user will be classified as “bad”. This will reduce background noise. In this embodiment, request analyzer 120 may produce two scores G and B per HTTP request, where score G is the score against the good behavior database and score B is the scores against the bad behavior database. The final score will reflect which database describes the request better, its bad score or good score. Mathematically, this is expressed as following:

Combined Score=(((B−G)/(B+G))+1)/2 Equation 15

In another embodiment, system 10 may enable the system administrator to choose, per application or user, which elements of the HTTP request should or should not be inspected, as well as to choose a weight for each one (1 by default) that will affect its weight in the total score.

### A Hybrid Model for Fraud Detection

System 10, described hereinabove, may be used to build custom rules that combine both statistical and deterministic criteria in order to trigger an alert in the system. System 10 may comprise a rule editor 200 with which a system administrator may combine one or more rules to create a rule group. Rule groups typically chain rules with an AND logic (i.e. they all have to trigger in order to trigger the group).

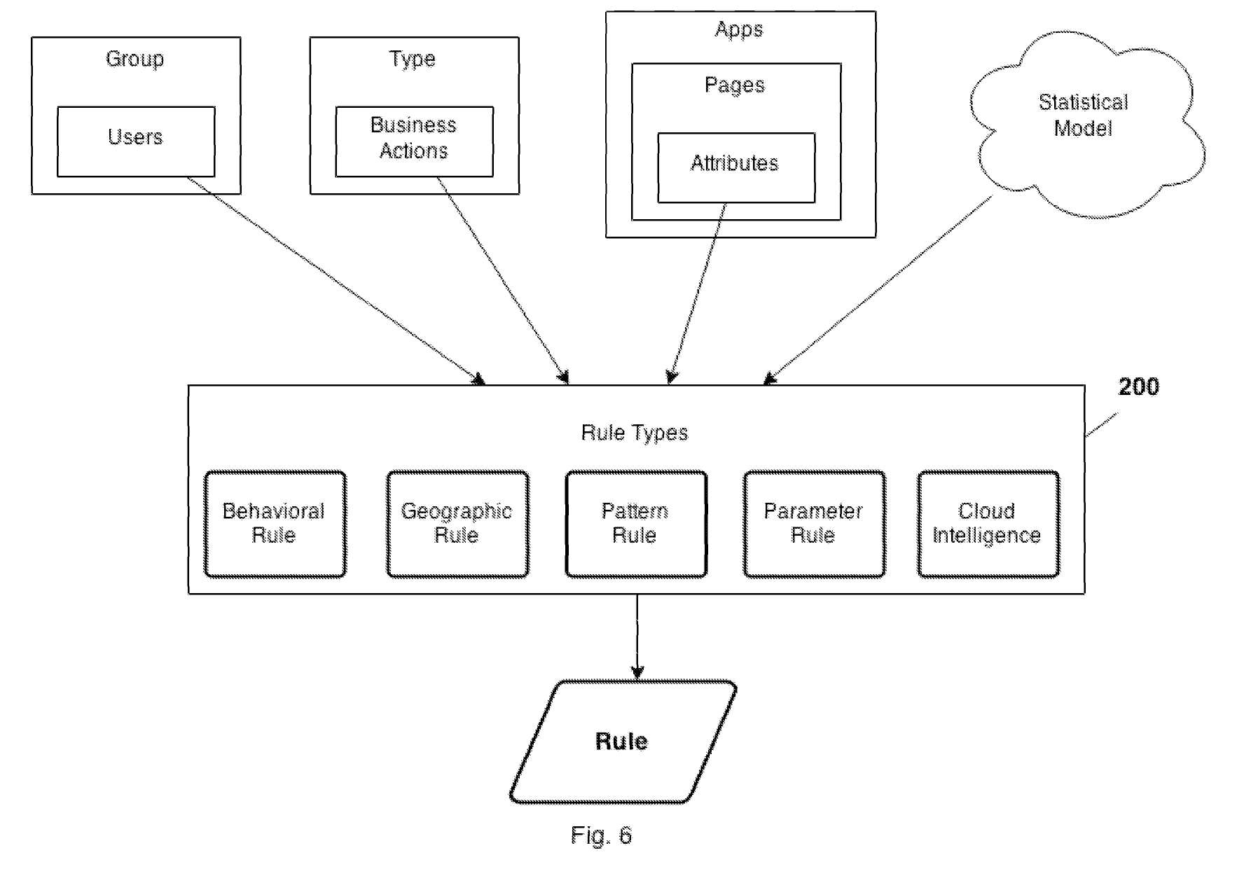

FIG. 6, to which reference is now made, depicts the process of rule generation. The system administrator can select one or more of the following criteria to limit the scope of where one rule applies and where it does not.
Users/user groups to which the rule is applicable
Business actions/business action types to which the rule is applicable
Attributes/pages/applications to which the rule is applicable
A statistical anomaly in click speed/navigation/query or geographic location of the web user
   The following types of rules are at the system administrator's disposal:
Behavioral rule—allowing the administrator to trigger alerts based on a certain level of anomaly in a user session. This is based on one of the analysis methods mentioned earlier including, but not limited to: geographic location of the user, click speed between two or more pages, navigation pattern between requests, query (computed from all parameter anomaly scores)
Geographic rule—Trigger based on the Geographic location that a request came from. Also with an option to trigger based on the user's velocity, based on distance/time covered between subsequent requests from the same user.
Pattern rule—This enables the system administrator to correlate patterns of user's behavior.
Parameter rule—Trigger based on properties of a certain parameter (or group of parameters)
   Having a certain value (based on deterministic values or heuristic values based on the statistical model)
   Too long/short (based on deterministic values or heuristic values based on the statistical model)
   Having certain characters (based on deterministic values or heuristic values based on the statistical model)
   String similarity—employs a string similarity algorithm on a certain parameter. If too many subsequent requests show resemblance in values per a certain attribute, it could trigger a rule. The string similarity is calculated using the Levenshtein algorithm.
   (http://en.wikipedia.org/wiki/levenshtein_distance)
   For example, the system can detect a login abuse or scraping attempt by detecting strings that repeat, with 1-2 character difference apart between them.
Cloud intelligence—Trigger based on match to patterns that are found in the system's knowledge base, and are updated constantly. For instance: known bot IP addresses and Tor exit nodes (peer-to-peer proxy networks)

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMS), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A business action fraud detection system for a website, the system comprising:
a business action classifier to classify a series of operations from a single web session as a business action; and
a fraud detection processor to determine a score for each operation from the statistical comparison of the data of each request forming part of the operation against statistical models generated from data received in at least one of a training phase and a production phase, said score combining probabilities that the transmission and navigation activity of a session are those expected of a normal user.

2. The fraud detection system of claim 1 wherein said processor comprises a query analyzer to analyze at least one of: textual, numerical, enumeration and URL values within parameters sent in an incoming website request.

3. The fraud detection system of claim 1 wherein said processor comprises analyzers to analyze at least one of: geo-location of an HTTP session, trajectory to a webpage of an HTTP session and landing speed parameters to said web page of an HTTP session.

4. The fraud detection system of claim 1 wherein said processor comprises an operation classifier to determine which operation was requested in an HTTP request.

5. The fraud detection system of claim 1 and also comprising at least one statistical model storing the statistics of operation determined during at least one of a training phase and a production phase of said system.

6. The fraud detection system of claim 5 and wherein said at least one statistical model is at least one statistical model per the population of users and at least one statistical model per user.

7. The fraud detection system of claim 5 and wherein said statistical models include at least an operations model, a trajectory model, a geolocation model, a query model per operation and a business action model.

8. The fraud detection system of claim 1 and also comprising a rule editor to enable an administrator to define at least one rule that combines both statistical and deterministic criteria in order to trigger an alert in said system.

9. The fraud detection system of claim 8 and wherein each said rule is at least one of the following types of rules: behavioral rule, geographic rule, pattern rule, parameter rule and cloud intelligence rule.

10. A method for detecting business action fraud on a website, the method comprising:
classifying a series of operations from a single web session as a business action; and
determining a score for each operation from a statistical comparison of the data of each request forming part of the operation against statistical models generated from data received in a training phase, said score combining probabilities that the transmission and navigation activity of a session are those expected of a normal user.

11. The method of claim 10 wherein said determining comprises analyzing at least one of: textual, numerical, enumeration and URL values within parameters in an incoming website request.

12. The method of claim 10 wherein said determining comprises analyzing at least one of: geo-location of an HTTP session, trajectory to a webpage of an HTTP session and landing speed parameters to said web page of an HTTP session.

13. The method of claim 10 wherein said determining comprises classifying which operation was requested in an HTTP request.

14. The method of claim 10 and also comprising at least one statistical model storing the statistics of operation determined during a training phase of said system.

15. The method of claim 14 and wherein said at least one statistical model is at least one statistical model per the population of users and at least one statistical model per user.

16. The method of claim 14 and wherein said statistical models include at least an operations model, a trajectory model, a geolocation model, a query model per operation and a business action model.

17. The method of claim 10 and also comprising a rule editor to enable an administrator to define at least one rule that combines both statistical and deterministic criteria in order to trigger an alert in said system.

18. The method of claim 17 and wherein each said rule is at least one of the following types of rules: behavioral rule, geographic rule, pattern rule, parameter rule and cloud intelligence rule.
